(19) United States
(12) Patent Application Publication
(10) Pub. No.: US 2015/0178927 A1
(43) Pub. Date: Jun. 25, 2015

(54) METHOD AND SYSTEM FOR DETERMINING A TRANSFORMATION ASSOCIATED WITH A CAPTURING DEVICE

(71) Applicant: Metaio GmbH, Munich (DE)

(72) Inventor: Thomas Olszamowski, Munich (DE)

(73) Assignee: Metaio GmbH, Munich (DE)

(21) Appl. No.: 14/139,298

(22) Filed: Dec. 23, 2013

(51) Int. Cl. G06T 7/00

(52) U.S. Cl. CPC G06T 7/0042; G06T 2207/10004; G06T 2207/30244; G06T 2207/20048

(57) ABSTRACT

A method and system for determining a transformation associated with a capturing device are provided. Aspects of the method include the steps of: providing or receiving a first plurality of features of a real object captured by the capturing device; providing or receiving a second plurality of features associated with the real object; estimating a first plurality of transformations associated with the capturing device according to the first and second plurality of features, the transformations including translational and rotational components; determining a second plurality of transformations which is a subset of the first plurality of transformations, matching each of the second plurality of transformations against other ones of the second plurality of transformations, and computing at least one score parameter for each of the second plurality of transformations; and selecting among the second plurality of transformations at least one transformation based on its at least one score parameter in comparison with respective score parameters of other ones of the second plurality of transformations.

### BACKGROUND OF THE INVENTION

1. Technical Field

The present disclosure is related to a method for determining a transformation associated with a capturing device, which comprises providing or receiving a first plurality of features of a real object captured by the capturing device, providing or receiving a second plurality of features of the real object, and estimating a first plurality of transformations associated with the capturing device according to the first plurality of features and the second plurality of features, the transformations including a translational component and a rotational component. The translational component may be zero (i.e. no translational motion). The rotational component may also be zero (i.e. no rotational motion). The disclosure also relates to a corresponding system and computer program product, particularly a computer readable medium.

2. Background Information

Localization of a camera in a known real environment is a common task in multiple application fields. For example, it may be used to determine the position of a robot in the real environment or to overlay virtual visual content (i.e. computer generated object) onto the real environment, such as in an Augmented Reality (AR) application. AR systems and applications are known to enhance a view of a real environment by providing a visualization of overlaying computer-generated virtual information with a view of the real environment. The virtual information can be any type of visually perceivable data such as objects, texts, drawings, videos, or their combination. The view of the real environment could be perceived as visual impressions by user's eyes and/or be acquired as one or more images captured by a camera held by a user or attached on a device held by a user.

In the art, localization of a camera is also called camera pose estimation for determining a pose of the camera relative to the real environment. The pose describes a transformation including a translational part and a rotational part. Localizing the camera without prior knowledge of the pose is very challenging. A common workflow to solve this problem is to extract 2D features in an image of the real environment captured by the camera and match them with 3D features of the real environment with known 3D positions. A depth camera that provides depth information could be used to provide such 3D features from its captured image. A 2D feature describes the feature with a position in 2D (e.g. a pixel position in the image). A 3D feature describes the feature with a position in 3D. The features in this context are geometric features, like corners, edges, blobs, points, etc. The pose can be determined based on 2D-3D or 3D-3D feature correspondences. However, it is suffering from the problem of incorrect matched feature correspondences or large errors in detected feature locations, which are commonly referred to as outliers. Accurate pose estimation requires rejection of such outliers.

Common solutions for detecting outliers are hypothesize-and-test methods, such as random sample consensus (RANSAC), see Hartley, Richard, and Andrew Zisserman. Multiple view geometry in computer vision. Vol. 2. Cambridge, 2000, (“Hartley”) and its variants. A problem using RANSAC for pose estimation could be that the method may determine multiple significant different poses having similar estimated errors (e.g. image re-projection errors, number of inliers), which makes it difficult to choose a correct pose from the multiple significant different poses based on similar estimated errors.

PCT Publication WO 2011/163341 A1 (“Barroah”) describes a method to compute a robust camera pose using RANSAC. Instead of choosing one of the many hypotheses (i.e. poses) generated based on determined feature correspondences, Barroah proposes to average the hypotheses in order to obtain an average estimate. Barroah considers the average estimate more accurate and robust than any of the individual hypotheses and thus chooses the average hypothesis (i.e. pose) as the robust camera pose. In Barroah, the rotational component of the robust camera pose is computed by averaging the rotations of the hypotheses using quaternions, and the translational component of the robust camera pose is computed by averaging the translations of the hypotheses.

U.S. Patent Publication 2013/0156262 A1 (“Taguchi”) presents a similar method as Barroah to compute a camera pose using RANSAC. Taguchi proposes a voting scheme and clustering hypotheses (i.e. poses) generated based on feature correspondences. Then, the final camera pose is computed as the average of the candidate hypotheses (i.e. poses) within a cluster having the largest numbers of votes.

In both Barroah and Taguchi, the computed final camera pose is not the same as any of the individual hypotheses, i.e. not existing before. One common problem in both Barroah and Taguchi is that the average pose may largely differ from the true pose. This may happen quite often particularly when a long focal length camera is used which is close to an orthographic projection.

Therefore, it would be desirable to provide a method for determining a transformation associated with a capturing device which is capable of determining an improved pose of the capturing device.

### SUMMARY OF THE INVENTION

According to an aspect of the present invention, there is disclosed a method for determining a transformation associated with a capturing device, which comprises providing or receiving a first plurality of features of a real object captured by the capturing device, providing or receiving a second plurality of features associated with the real object, estimating a first plurality of transformations associated with the capturing device according to the first plurality of features and the second plurality of features, the transformations each including a translational component and a rotational component, determining a second plurality of transformations which is a subset of the first plurality of transformations, matching each of the second plurality of transformations against respective other ones of the second plurality of transformations, and computing at least one score parameter for each of the second plurality of transformations based on a result of the matching, and selecting among the second plurality of transformations at least one transformation based on its at least one score parameter in comparison with respective score parameters of other ones of the second plurality of transformations. For example, the translational component may be zero (i.e. no translational motion). According to another example, the rotational component may be zero (i.e. no rotational motion).

According to another aspect of the present invention, there is disclosed a system for determining a transformation associated with a capturing device, comprising a processing device which is configured to provide or receive a first plurality of features of a real object captured by the capturing device, to provide or receive a second plurality of features associated with the real object, to estimate a first plurality of transformations associated with the capturing device according to the first plurality of features and the second plurality of features, the transformations each including a translational component and a rotational component, to determine a second plurality of transformations which is a subset of the first plurality of transformations, to match each of the second plurality of transformations against respective other ones of the second plurality of transformations, and compute at least one score parameter for each of the second plurality of transformations based on a result of the matching, and to select among the second plurality of transformations at least one transformation based on its at least one score parameter in comparison with respective score parameters of other ones of the second plurality of transformations. For example, the translational component may be zero (i.e. no translational motion). According to another example, the rotational component may be zero (i.e. no rotational motion).

In contrast to obtaining an average hypotheses, the present invention is capable of selecting a more accurate one from the hypotheses. Aspects of the present invention may advantageously be used to select a pose of the capturing device from good candidate hypotheses. The good candidate hypotheses are preferably determined according to supporting hypothesis that is computed based on differences between rotational components of the hypotheses generated based on feature correspondences. Furthermore, the present invention is appropriate to determine whether the selected pose is valid, or not, based on supporting hypothesis, which would reduce the false-positive rate.

According to another aspect of the present invention, a computer program product is provided comprising software code sections which are adapted to perform a method according to the invention. Particularly, the software code sections are contained on a computer readable medium which is non-transitory. The software code sections may be loaded into a memory of one or more processing devices as described herein. Any processing devices used with the software code sections may communicate via a communication network, e.g. via a server computer or a point to point communication, as described herein.

For example, the processing device is at least partially comprised in a mobile device which is associated with the capturing device, and/or in a computer device which is adapted to remotely communicate with the capturing device, such as a server computer adapted to communicate with the capturing device or mobile device associated with the capturing device. The system according to aspects of the invention may be comprised in only one of these devices, or may be a distributed system in which one or more processing tasks are distributed and processed by one or more components which are communicating with each other, e.g. by point to point communication or via a network.

### BRIEF DESCRIPTION OF THE DRAWINGS

Aspects and embodiments of the invention will now be described with respect to the drawings.

FIG. 1 shows a flow diagram of an embodiment of a method for determining a pose of a camera relative to a real object according to aspects of the invention.

FIG. 2 shows an exemplary scenario of a camera and a real object locating in a real environment.

### DETAILED DESCRIPTION OF THE INVENTION

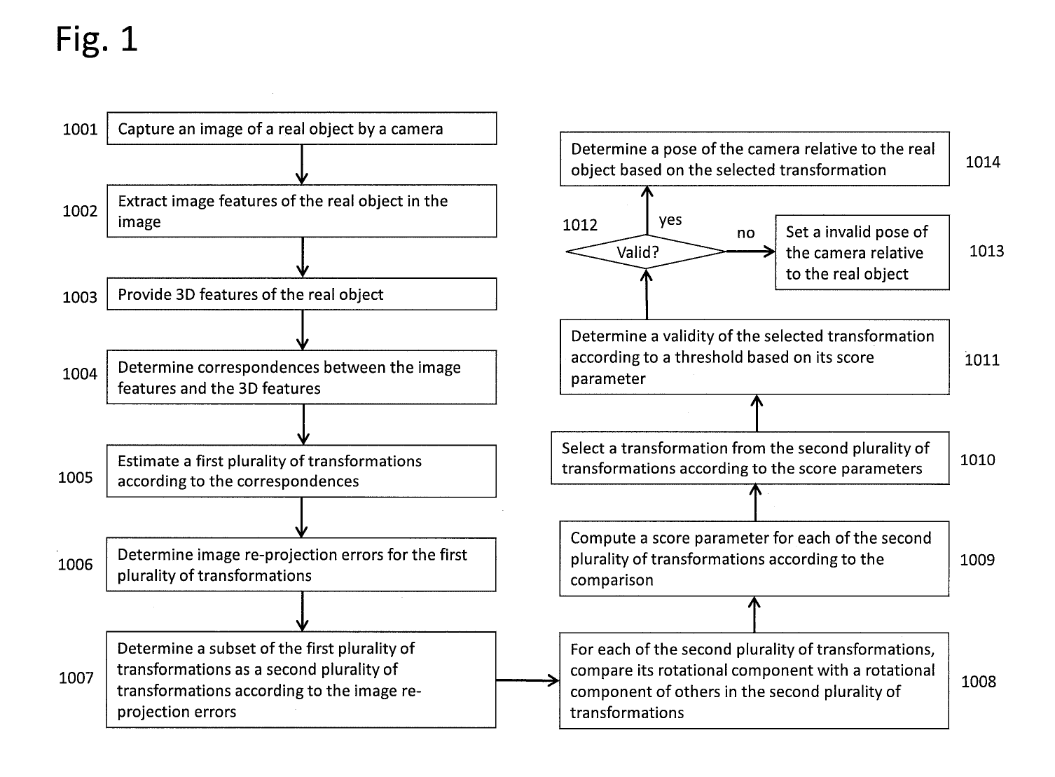

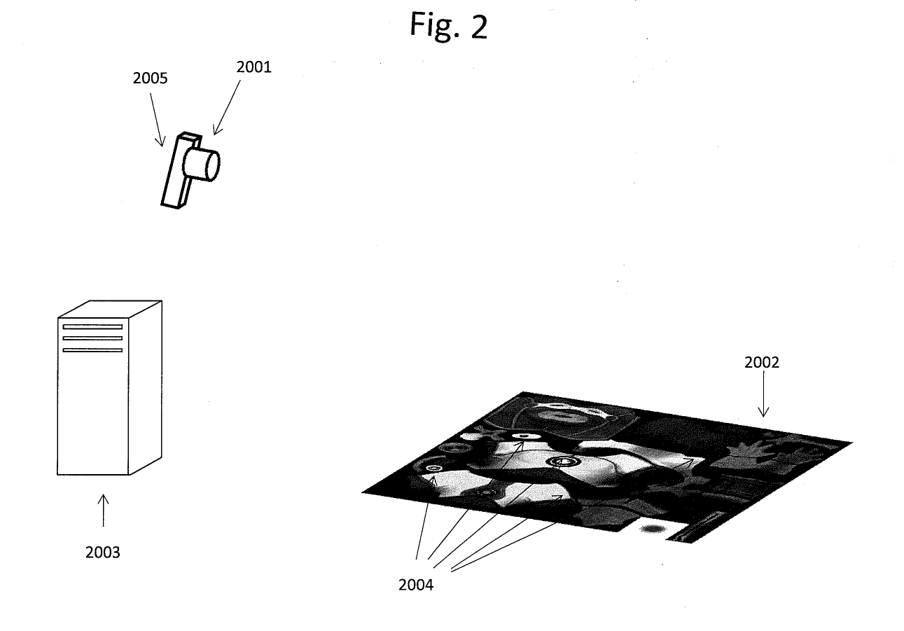

In the following description of embodiments, it is referred to FIG. 1 in connection with an exemplary scenario as shown in FIG. 2.

Referring now to jointly to FIGS. 1 and 2, in step 1001, a camera 2001, which generally is a capturing device for capturing images, is used to capture an image of a real object 2002. The real object may be entirely or partially captured in the image. The real object may have any shape which is two or three dimensional, i.e. is a 2D real object or a 3D real object. In step 1002, image features of the real object in the image are extracted. In the present example, points and/or corners 2004 of the real object or a part of the real object in the image could be extracted from the image as 2D image (point) features having pixel positions. These features are examples of a first plurality of features of a real object as mentioned herein.

Any points or corners of the real object 2002, for example, could further be described as 3D (point) features, which are provided in step 1003. For example, the 3D features are provided from a known 3D geometrical model of the real object or a part thereof. Such 3D features may have positions in a coordinate system of the real object 2002, and are thus associated with the real object. These features are examples of a second plurality of features associated with the real object as mentioned herein.

Step 1004 determines correspondences between the image features provided in step 1002 and the 3D features provided in step 1003. This may be realized by feature matching that compare a similarity between the image features and the 3D features. Matching the image features and the 3D features could be done by determining a respective similarity measure between each respective feature of the image features and each respective feature of the 3D features. Common examples of image similarity measures include the negative or inverted sum-of-squared differences (SSD), negative or inverted sum of absolute differences (SAD), (normalized) cross-correlation, and mutual information. The result of a similarity is a real number. The bigger the similarity measure result is, the more similar the two visual features are.

The simplest approach to feature matching is to find the nearest neighbor of the current feature (here: image feature) by means of exhaustive search and choose the corresponding reference feature (here: 3D feature) as match. More advanced approaches employ spatial data structures in the descriptor domain to speed up matching. Common approaches use an approximate nearest neighbor search instead, e.g. enabled by space partitioning data structures such as kd-trees described in Lowe, David G. “Distinctive Image Features from Scale-Invariant Keypoints.” International Journal of Computer Vision 60.2 (2004): 91-110.

The comparison and matching of features may also be performed by computing differences (e.g. pixel intensity differences) between image patches using methods such as the sum of squared differences (SSD), normalized cross correlation (NCC).

Step 1005 estimates a first plurality of transformations according to the correspondences. In the present embodiment, the transformations are camera poses. The transformations may also be projective transformations, i.e. including camera poses and camera intrinsic parameters (see, e.g., Hartley). Intrinsic parameters of the camera may be pre-known or calibrated in an off-line procedure. Several methods are known for determining a camera pose based on correspondences; e.g., see Hartley, or Petersen, Thomas “A Comparison of 2D-3D Pose Estimation Methods.” Master's thesis, Aalborg University-Institute for Media Technology Computer Vision and Graphics, Lautrupvang. For example, having known intrinsic parameters of the camera, at least three correspondences between three image points and three 3D points are sufficient to compute a pose (e.g., see Hartley).

At least three arbitrary correspondences are selected to compute a transformation, which is a camera pose, as disclosed in Hartley. This procedure could be performed multiple times to obtain the first plurality of transformations.

All or at least a plurality of the 3D point features may be projected onto a coordinate system of the image by a projective transformation based on one computed transformation and the camera intrinsic parameters in order to get the projected position of the 3D point features.

In step 1006, image re-projection errors for the first plurality of transformations are determined. For example, an image re-projection error for one computed transformation is estimated based on the projected position of the 3D point features and corresponding image point features, as disclosed in Hartley. This procedure could be performed for each of the first plurality of transformations in order to obtain image a re-projection error for the respective transformation.

In step 1007, a subset of the first plurality of transformations is determined as a second plurality of transformations, preferably according to the image re-projection errors determined previously. It is preferred to select transformations that have the lowest re-projection errors among the first plurality of transformations as the second plurality of transformations.

For each of the second plurality of transformations, step 1008 compares at least one component of the respective transformation with at least one component of others of the second plurality of transformations. In the present embodiment, for each of the second plurality of transformations, there is compared its rotational component with a rotational component of others of the second plurality of transformations. For example, two rotations may be compared to compute an angle between these rotations using a method as proposed in Huynh, Du Q. “Metrics for 3D rotations: Comparison and analysis.” Journal of Mathematical Imaging and Vision 35.2 (2009): 155-164. For one of the second plurality of transformations, angles between its rotation and rotation of others in the second plurality of transformations may be determined.

In step 1009, a score parameter for each of the second plurality of transformations according to the comparison is computed. For example, there is selected one transformation of the second plurality of transformations, and angles between the rotational component of the selected transformation and respective rotational components of other transformations in the second plurality of transformations may be determined. If an angle is above a threshold, this may be determined to correspond to a bad support, while if an angle is below the threshold, this may be determined to correspond to a good support. Thus, in this embodiment, for each computed angle of a selected transformation, a respective good or bad support is determined, so that each transformation comprises, at the end of the calculation, a number of good and/or bad supports corresponding to the number of computed angles. The number of good supports may be used as a score parameter for the selected transformation. In another example, the score parameter may be computed based on a sum of the angles or a part of the angles.

Step 1010 then selects a transformation from the second plurality of transformations according to the score parameters. For example, a transformation that has the most good supports (i.e. the highest score parameter) among the second plurality of transformations may be selected. In another example, a transformation that has the smallest sum of the angles (i.e. the smallest score parameter) among the second plurality of transformations may be selected.

Further, a validity of the selected transformation may be determined based on its score parameter in step 1011, for example according to a threshold. In order to improve false-positive errors, it is preferred to further check the validity of the selected transformation by checking if the score parameter is above the threshold. For example, check if the number of good supports is above a pre-defined number. Checking the validity is beneficial in, e.g., a case in which all of the second plurality of transformations may have a small number of good supports and, thus, it may not be possible to compute an accurate pose.

If the selected transformation is valid, then a pose of the camera relative to the real object is determined based on the selected transformation (which corresponds to a pose) in step 1014. Otherwise, an invalid pose of the camera relative to the real object is set in step 1013.

In an embodiment in which a camera could also provide depth information, like a RGB-D camera, 3D positions of the points or corners 2004 of the real object or a part of them, that are captured in the image, could be extracted from the image as image (point) features. These 3D positions of the image features may be defined in a coordinate system associated to the camera. The proposed embodiment described above (e.g. in FIG. 1) could also be applied. In this case, the first plurality of transformations may be determined based on the 3D positions of the image features and corresponding 3D features according to a method as disclosed in Umeyama, Shinji. “Least-squares estimation of transformation parameters between two point patterns.” Pattern Analysis and Machine Intelligence, IEEE Transactions on 13.4 (1991): 376-380. Further, instead of determining image re-projection errors in step 1006, euclidean distances (errors) may be determined. For example, the euclidean distances are between transformed 3D positions of the image features based on the first plurality of transformations and the corresponding 3D features.

FIG. 2 shows a scenario in which the camera 2001 is pointing to the real object (here: a planar object 2002) for capturing one or more images thereof. The camera 2001 may communicate with a computer 2003 (such as a remote server computer) via cable or wirelessly, e.g. via a computer network (such as the Internet) or via point to point communication. The procedure disclosed above may be performed at least partially in a processing device (not explicitly shown) in the computer 2003. According to an embodiment, the camera 2001 may be associated with a mobile device 2005 having a processing device (not explicitly shown). For example, the camera 2001 may be integrated into the mobile device 2005, such as a mobile phone or a tablet computer. For example, the procedure disclosed above may at least partially be performed in such processing device. According to another embodiment, the procedure as disclosed above may be performed jointly by the processing devices contained in the mobile device 2005 and the computer 2003.

Generally, the following aspects and embodiments may be applied individually or in any combination in connection with aspects of the present invention.

A feature of a real object is used to denote a piece of information related to the real object. The piece of information may be visually perceivable to anatomical eyes or optical imaging devices. For example, the object may emit or reflect visible light that could be captured by human eyes or cameras. The real object may also emit or reflect invisible light that could not be captured by human eyes, but could be captured by a camera (i.e. is optically perceivable).

A feature may describe specific colors and/or structures, such as blobs, edges points, a particular region, and/or more complex structures of the real object. The feature may be represented by an image patch (e.g. pixel intensity) or a high level descriptor (e.g. SIFT, see Lowe, David G. “Object recognition from local scale-invariant features.” Computer vision, 1999. The proceedings of the seventh IEEE international conference on. Vol. 2. Ieee, 1999). A feature may have 3D position and/or 3D orientation information in 3D Euclidean space relative to a coordinate system of the real object. The feature may also be expressed in 2D space. For example, the feature may be extracted from an image of the real object captured by a camera, and thus the feature may have 2D image position and/or orientation in a coordinate system of the image. When a camera could provide depth information, the feature extracted from an image of the camera may also have 3D position and/or orientation information.

A transformation describes a spatial relationship between two objects, i.e. specifies how an object is located in 2D or 3D space in relation to another object in terms of translation, and/or rotation, and/or scale. The transformation may be a rigid transformation or could also be a similarity transformation. A pose of a camera relative to a coordinate system is typically a rigid transformation.

According to an embodiment, matching each of the second plurality of transformations against respective other ones of the second plurality of transformations comprises that for each of the second plurality of transformations at least one of its components is compared with at least one corresponding component of other ones of the second plurality of transformations.

According to a further embodiment, each of the second plurality of transformations is matched against respective other ones of the second plurality of transformations according to their respective rotational component, wherein the result of the matching is based on a difference between respective matched rotational components.

According to an embodiment, the method further comprises determining correspondences between the first plurality of features and the second plurality of features, wherein the transformations of the first plurality of transformations are estimated according to the correspondences.

For example, the correspondences are determined according to at least one similarity measure.

According to an embodiment, the first and/or second plurality of features describes optically perceivable features with colors and/or structures. For example, the second plurality and/or first plurality of features describes visually visible (including infrared) features with specific colors and/or structures, such as blobs, edges and/or points of the real object. Accordingly, the optically perceivable features with colors or structures may be at least one of blobs, edges and points of the real object.

According to an embodiment, the capturing device is a camera which is adapted to capture an image of the real object or a part of the real object. The first plurality of features may include 2D features extracted from the image of the real object or part of the real object, and the second plurality of features may include 3D features associated with the real object. The transformations of the first and second plurality of transformations may describe respective poses of the camera relative to the real object.

For example, the second plurality of transformations is determined according to re-projection errors determined from an image re-projection using the first plurality of transformations.

According to an embodiment, the first plurality of features include 3D features of the real object in a first coordinate system, and the second plurality of features include 3D features associated with the real object in a second coordinate system. The transformations of the first and second plurality of transformations each describe a spatial relationship between one of the first plurality of features in the first coordinate system and one of the second plurality of features in the second coordinate system.

For example, the second plurality of transformations is determined according to euclidean distances.

According to an embodiment, the method further comprises determining a validity of the selected at least one transformation according to a threshold and the at least one score parameter of the selected at least one transformation.

Although various embodiments are described herein with reference to certain components or devices, any other configuration of components or devices, as described herein or evident to the skilled person, can also be used when implementing any of these embodiments. Any of the devices or components as described herein may be or may comprise a respective processing device (not explicitly shown), such as a microprocessor, for performing some or more of the tasks as described herein. One or more of the processing tasks may be processed by one or more of the components or their processing devices which are communicating with each other, e.g. by a respective point to point communication or via a network, e.g. via a server computer.

What is claimed is:

1. A method for determining a transformation associated with a capturing device, comprising the steps of:
providing or receiving a first plurality of features of a real object captured by the capturing device;
providing or receiving a second plurality of features associated with the real object;
estimating a first plurality of transformations associated with the capturing device according to the first plurality of features and the second plurality of features, the transformations including a translational component and a rotational component;
determining a second plurality of transformations which is a subset of the first plurality of transformations;
matching each of the second plurality of transformations against respective other ones of the second plurality of transformations, and computing at least one score parameter for each of the second plurality of transformations based on a result of the matching; and
selecting among the second plurality of transformations at least one transformation based on its at least one score parameter in comparison with respective score parameters of other ones of the second plurality of transformations.

2. The method according to claim 1, wherein matching each of the second plurality of transformations against respective other ones of the second plurality of transformations comprises that for each of the second plurality of transformations at least one of its components is compared with at least one corresponding component of other ones of the second plurality of transformations.

3. The method according to claim 1, wherein each of the second plurality of transformations is matched against respective other ones of the second plurality of transformations according to their respective rotational component, wherein the result of the matching is based on a difference between respective matched rotational components.

4. The method according to claim 1, further comprising the step of determining correspondences between the first plurality of features and the second plurality of features, wherein the transformations of the first plurality of transformations are estimated according to the correspondences.

5. The method according to claim 4, wherein the correspondences are determined according to at least one similarity measure.

6. The method according to claim 1, wherein at least one of the first and second plurality of features describes optically perceivable features with colors or structures.

7. The method according to claim 6, wherein the optically perceivable features with colors or structures are at least one of blobs, edges and points of the real object.

8. The method according to claim 1, wherein:
the capturing device is a camera which is adapted to capture an image of the real object or a part of the real object, the first plurality of features include 2D features extracted from the image of the real object or part of the real object;
the second plurality of features include 3D features associated with the real object; and
the transformations of the first and second plurality of transformations describe respective poses of the camera relative to the real object.

9. The method according to claim 8, wherein the second plurality of transformations is determined according to re-projection errors determined from an image re-projection using the first plurality of transformations.

10. The method according to claim 1, wherein:
the first plurality of features include 3D features of the real object in a first coordinate system;
the second plurality of features include 3D features associated with the real object in a second coordinate system; and
the transformations of the first and second plurality of transformations each describe a spatial relationship between one of the first plurality of features in the first coordinate system and one of the second plurality of features in the second coordinate system.

11. The method according to claim 10, wherein the second plurality of transformations is determined according to Euclidean distances.

12. The method according to claim 1, further comprising the step of determining a validity of the selected at least one transformation according to a threshold and the at least one score parameter of the selected at least one transformation.

13. A non-transitory computer readable medium comprising software code sections which are adapted to perform a method including the steps of:
providing or receiving a first plurality of features of a real object captured by the capturing device;
providing or receiving a second plurality of features associated with the real object;
estimating a first plurality of transformations associated with the capturing device according to the first plurality of features and the second plurality of features, the transformations including a translational component and a rotational component;
determining a second plurality of transformations which is a subset of the first plurality of transformations;
matching each of the second plurality of transformations against respective other ones of the second plurality of transformations, and computing at least one score parameter for each of the second plurality of transformations based on a result of the matching; and
selecting among the second plurality of transformations at least one transformation based on its at least one score parameter in comparison with respective score parameters of other ones of the second plurality of transformations;
when running on a processing device.

14. A system for determining a transformation associated with a capturing device, comprising:
a processing device which is configured:
to provide or receive a first plurality of features of a real object captured by the capturing device;
to provide or receive a second plurality of features associated with the real object;
to estimate a first plurality of transformations associated with the capturing device according to the first plurality of features and the second plurality of features, the transformations including a translational component and a rotational component;
to determine a second plurality of transformations which is a subset of the first plurality of transformations;
to match each of the second plurality of transformations against respective other ones of the second plurality of transformations, and compute at least one score parameter for each of the second plurality of transformations based on a result of the matching, and
to select among the second plurality of transformations at least one transformation based on its at least one score parameter in comparison with respective score parameters of other ones of the second plurality of transformations.

15. The system according to claim 14, wherein the processing device is at least partially comprised in a mobile device which is associated with the capturing device.

16. The system according to claim 14, wherein the processing device is at least partially comprised in a computer device which is adapted to remotely communicate with the capturing device.
